(19) United States
(12) Patent Application Publication
(10) Pub. No.: US 2011/0182624 A1
(43) Pub. Date: Jul. 28, 2011

(54) DEVELOPING DEVICE AND IMAGE FORMING APPARATUS USING THE DEVELOPING DEVICE

(76) Inventors: Koichi MIHARA, Osaka (JP); Takafumi Nagai, Osaka (JP)

(21) Appl. No.: 13/013,078

(22) Filed: Jan. 25, 2011

(30) Foreign Application Priority Data
Jan. 25, 2010 (JP) 2010-013175

(51) Int. Cl. G03G 15/08

(52) U.S. Cl. 399/254

(57) ABSTRACT

A developing device includes a developer container for containing a developer including a toner and a magnetic carrier; a developer conveying path provided in the developer container; a developer conveying member, provided in the developer conveying path, for agitating and conveying the developer; and a developing roller for holding the agitated developer so that the toner included in the developer is supplied to a photoconductor drum, wherein the developer conveying member includes a rotating shaft, and an undulated helical blade provided along an outer circumference of the rotating shaft.

### CROSS-REFERENCE TO RELATED APPLICATION

This application is related to Japanese patent application No. 2010-013175 filed on Jan. 25, 2010 whose priority is claimed under 35 USC §119, the disclosure of which is incorporated by reference in its entirety.

### BACKGROUND OF THE INVENTION

1. Field of the Invention

The present invention relates to a developing device and an image forming apparatus using the developing device, and more particularly to a developing device which is used for an image forming apparatus, such as an electrostatic copying machine, a laser printer, and a facsimile machine, for forming an image by using toner in an electrophotographic method, and which uses a two-component developer including a toner and a magnetic carrier, and to an image forming apparatus using the developing device.

2. Description of the Related Art

Conventionally, an image forming apparatus, such as a copying machine, a printer, and a facsimile machine, using an electrophotographic method is known. In the image forming apparatus using the electrophotographic method, an electrostatic latent image is formed on a surface of a photoconductor drum (toner image holder), toner is supplied to the photoconductor drum by means of a developing device to develop the electrostatic latent image, a toner image formed on the photoconductor drum through the development is transferred onto a sheet such as a paper sheet, and the toner image is fused onto the sheet by means of a fuser unit.

In recent years, for a full-color compliant image forming apparatus and a high-definition compliant image forming apparatus, a two-component developer (hereinafter, referred to simply as a “developer”) is often used which is excellent in toner charging stability. The two-component developer includes a toner and a carrier. The toner and the carrier are agitated in a developing device, to generate a friction between the toner and the carrier, and the friction allows the toner to be appropriately charged.

In the developing device, the charged toner is supplied to a surface of a developer holder such as a developing roller. The toner having been supplied to the developing roller is transferred to an electrostatic latent image formed on a photoconductor drum, due to an electrostatic attraction. Thus, a toner image based on the electrostatic latent image is formed on the photoconductor drum.

Further, such an image forming apparatus is required to increase a speed and to have a reduced size. Therefore, it is necessary to immediately perform sufficient charging of a developer, and to immediately convey the developer.

Therefore, as a conventional art, a circulation-type developing device for use in an image forming apparatus is known which includes: two developer conveying paths which form a path for circulating and conveying a developer; and two auger screws for conveying the developer, while agitating the developer, in the two developer conveying paths, in order to immediately disperse the supplied toner in the developer to appropriately charge the toner (for example, see Japanese Unexamined Patent Application No. 2005-24592).

In such a circulation-type developing device, when a concentration of the toner in the developer in the developing device reduces to be less than a predetermined value, toner is supplied to the developer conveying paths from a toner hopper. A specific gravity of the toner is substantially less than a specific gravity of the carrier, that is, a specific gravity of the toner is about one third of a specific gravity of the carrier, so that the supplied toner is likely to float on the developer. Therefore, the conventional circulation-type developing device has a problem that, when an amount of toner supplied to the developer conveying paths is large, the toner is accumulated as a lump, and is conveyed as the lump on the developer, and, as a result, a toner (that is, an insufficiently charged toner which has not sufficiently contacted with the carrier) which has not been sufficiently mixed with the carrier is supplied to the developer holder.

On the other hand, when an auger screw is provided with, for example, a plate member (a circumferential direction agitating plate) which extends from and orthogonal to a rotating shaft of the auger screw in the radial direction of the auger screw, in order to enhance a developer agitating efficiency, a shear force is excessively increased in the developer, so that heat is generated in the toner included in the developer, thereby softening a resin component in the toner. As a result, additives of the toner are buried in toner particle surfaces, to thereby significantly reduce fluidity of the developer, so that a phenomenon in which the two-component developer has poor fluidity may occur, which causes image density reduction, and poor charging of the toner.

### SUMMARY OF THE INVENTION

The present invention is made in order to solve the aforementioned problems, and an object of the present invention is to provide a developing device, for circulating, conveying and agitating a developer by means of a conveying member, which enables enhancement of an efficiency for agitating a supplied toner and the developer without applying an excessive stress to the developer, thereby preventing image density reduction caused by the phenomenon in which a developer has poor fluidity, and image fogging caused by poor charging of the toner.

The present invention provides a developing device including: a developer container which contains a developer including a toner and a magnetic carrier; a developer conveying path provided in the developer container; a developer conveying member, provided in the developer conveying path, for agitating the developer while conveying the developer; and a developing roller for holding the developer having been agitated, and for supplying, to a photoconductor drum, the toner included in the developer. Further, in the developing device of the present invention, the developer conveying member includes a rotating shaft, and an undulated helical blade provided along an outer circumference of the rotating shaft.

According to the present invention, a helical blade of the developer conveying member has an undulated surface including a developer pressing surface having an angle of attack which regularly or irregularly changes. Therefore, in accordance with the rotation of the helical blade, the developer is conveyed in the axial direction (in the direction in which the rotating shaft of the developer conveying member extends), and the developer contacting with the helical blade is agitated in the circumferential direction (the circumferential direction of the rotation of the developer conveying member). Thus, the developer is greatly agitated in the circumferential direction (in the upward and downward direction). Therefore, the mixing efficiency for mixing between a supplied toner and the developer can be enhanced without applying an excessive stress to the developer, so that an obtained image can be prevented from being influenced by image density reduction caused by the phenomenon in which the developer has poor fluidity, and image fogging caused by poor charging of the toner.

### BRIEF DESCRIPTION OF THE DRAWINGS

FIG. 1 is a diagram illustrating a structure of an image forming apparatus according to an embodiment of the present invention.

FIG. 2 is an enlarged view illustrating a structure of a toner supply shown in FIG. 1.

FIG. 3 is a cross-sectional view taken in the direction of an arrow C-C shown in FIG. 2.

FIG. 4 is an enlarged view illustrating a structure of a developing device shown in FIG. 1.

FIG. 5 is a cross-sectional view taken in the direction of an arrow A-A shown in FIG. 4.

FIG. 6 is a cross-sectional view taken in the direction of an arrow B-B shown in FIG. 4.

FIG. 7 is an enlarged view of a main portion of a first agitation conveying member shown in FIG. 6.

FIG. 8 is an enlarged view of a main portion of a first inner helical blade shown in FIG. 7.

FIG. 9 is a development of a ring-shaped undulated helical blade, shown in FIG. 7, as viewed from the center of rotation of the first agitation conveying member in the rotation circumferential direction.

### DESCRIPTION OF THE PREFERRED EMBODIMENTS

A developing device of the present invention includes: a developer container which contains a developer including a toner and a magnetic carrier; a developer conveying path provided in the developer container; a developer conveying member, provided in the developer conveying path, for agitating the developer while conveying the developer; and a developing roller for holding the developer having been agitated, and for supplying, to a photoconductor drum, the toner included in the developer. Further, in the developing device of the present invention, the developer conveying member includes a rotating shaft, and an undulated helical blade provided along an outer circumference of the rotating shaft. The undulated helical blade is a helical blade that has an undulated surface including a developer pressing surface having an angle of attack which regularly or irregularly changes. Further, the angle of attack is an angle between an axis of the rotating shaft and a tangent line (developer pressing surface) to the helical blade.

According to the present invention, the helical blade of the developer conveying member has an undulated surface including a developer pressing surface having an angle of attack which regularly or irregularly changes. Therefore, in accordance with the rotation of the helical blade, the developer is conveyed in the axial direction (in the direction in which the rotating shaft of the developer conveying member extends), and the developer contacting with the helical blade is agitated in the circumferential direction (the circumferential direction of the rotation of the developer conveying member). Thus, the developer is greatly agitated in the circumferential direction (in the upward and downward direction). Therefore, the mixing efficiency for mixing between a supplied toner and the developer can be enhanced without applying an excessive stress to the developer.

Further, in the developing device of the present invention, the developer conveying member preferably includes: a rotating shaft; an inner helical blade provided along an outer circumference of the rotating shaft; and a ring-shaped undulated helical blade provided so as to contact with an outer circumference of the inner helical blade. The ring-shaped undulated helical blade is a helical blade which is ring-shaped as viewed along the rotation axis, and which has an undulated surface including a developer pressing surface having an angle of attack which regularly or irregularly changes.

In these features, the developer in the center portion of the developer conveying path (near the rotating shaft) is conveyed in a direction in which the rotating shaft extends, and only the developer on the upper portion of the developer conveying path into which a supplementary toner is supplied, is agitated in the circumferential direction, so that the supplementary toner can be efficiently mixed with the developer without excessively enhancing a stress on the developer.

Further, in the developing device of the present invention, the number of cycles in which the ring-shaped undulated helical blade varies in by 2-12 cycles/rotation. The number of cycles in which the ring-shaped undulated helical blade varies represents the number of local maximum values of the angle of attack contained in one rotation of the ring-shaped undulated helical blade about the rotating shaft.

When the number of cycles in which the ring-shaped undulated helical blade varies is less than two, the surface for pressing the developer in the circumferential direction is reduced, resulting in insufficient agitating in the circumferential direction. On the other hand, when the number of cycles in which the ring-shaped undulated helical blade varies is greater than 12, an area size of the surface for pressing the developer in the circumferential direction is reduced, resulting in insufficient agitating in the circumferential direction. However, when the number of the cycles is greater than or equal to 2, and is not greater than 12, an efficiency for agitating in the circumferential direction is enhanced.

Further, in the developing device of the present invention, it is preferable that the ring-shaped undulated helical blade has an attack angle which sequentially changes in accordance with rotation of the rotating shaft. That “the angle of attack sequentially changes” means that a smoothly curved surface including no bending point is formed.

In these features, when the developer is pressed by the ring-shaped undulated helical blade, the developer is moved along the surface of the ring-shaped undulated helical blade, thereby alleviating a shear force occurring in the developer in the circumferential direction.

Further, in the developing device of the present invention, the ring-shaped undulated helical blade preferably has a minimum attack angle of not less than 0 degree and not less than 25 degrees. A value of the angle of attack obtained when the developer is pressed in a predetermined developer conveying direction in accordance with rotation of the developer conveying member is defined as a positive value, and a value of the angle of attack obtained when the developer is pressed in a direction opposite to the predetermined developer conveying direction in accordance with rotation of the developer conveying member is defined as a negative value.

When a minimum angle of attack of the ring-shaped undulated helical blade is less than 0 degrees (that is, when the conveying direction is the opposite direction), the developer is likely to be accumulated, resulting in reduction of an agitating efficiency. On the other hand, when a minimum angle of attack of the ring-shaped undulated helical blade is greater than 25 degrees, an efficiency for agitating the developer in the circumferential direction is reduced.

According to the present invention, the minimum angle of attack of the ring-shaped undulated helical blade is greater than or equal to 0 degrees, and is not greater than 25 degrees. Therefore, an efficiency for agitating the developer in the circumferential direction can be enhanced without accumulating the developer.

Further, in the developing device of the present invention, the inner helical blade preferably has a maximum attack angle of not less than 45 degrees and not more than 60 degrees.

When a maximum angle of attack of the inner helical blade is less than 45 degrees, a driving force component, in the rotating direction, which is received by the developer from the ring-shaped undulated helical blade is relatively increased. Therefore, agitating of the developer in the circumferential direction is enhanced, so that heat generation is likely to occur in the developer due to a friction. On the other hand, when a maximum angle of attack of the inner helical blade is greater than 60 degrees, although a driving force component, in the direction in which the rotating shaft extends, which is received by the developer from the ring-shaped undulated helical blade is relatively increased, the conveying speed is reduced.

According to the present invention, the maximum angle of attack of the inner helical blade is greater than or equal to 45 degrees, and is not greater than 60 degrees. Therefore, both the conveying speed and agitating efficiency for the developer can be appropriately improved .

Further, another aspect of the present invention is directed to an image forming apparatus which includes: a photoconductor drum having a surface on which an electrostatic latent image is formed; a charging unit for charging the surface of the photoconductor drum; an exposure unit for forming the electrostatic latent image on the surface of the photoconductor drum; a developing device for supplying a toner to the electrostatic latent image on the surface of the photoconductor drum, to form a toner image; a transfer unit for transferring, to a recording medium, the toner image on the surface of the photoconductor drum; a fuser unit for fusing, onto the recording medium, the toner image having been transferred; and the developing device according to the present invention.

Hereinafter, the present invention will be described based on an embodiment in conjunction with the drawings.

### [Image Forming Apparatus]

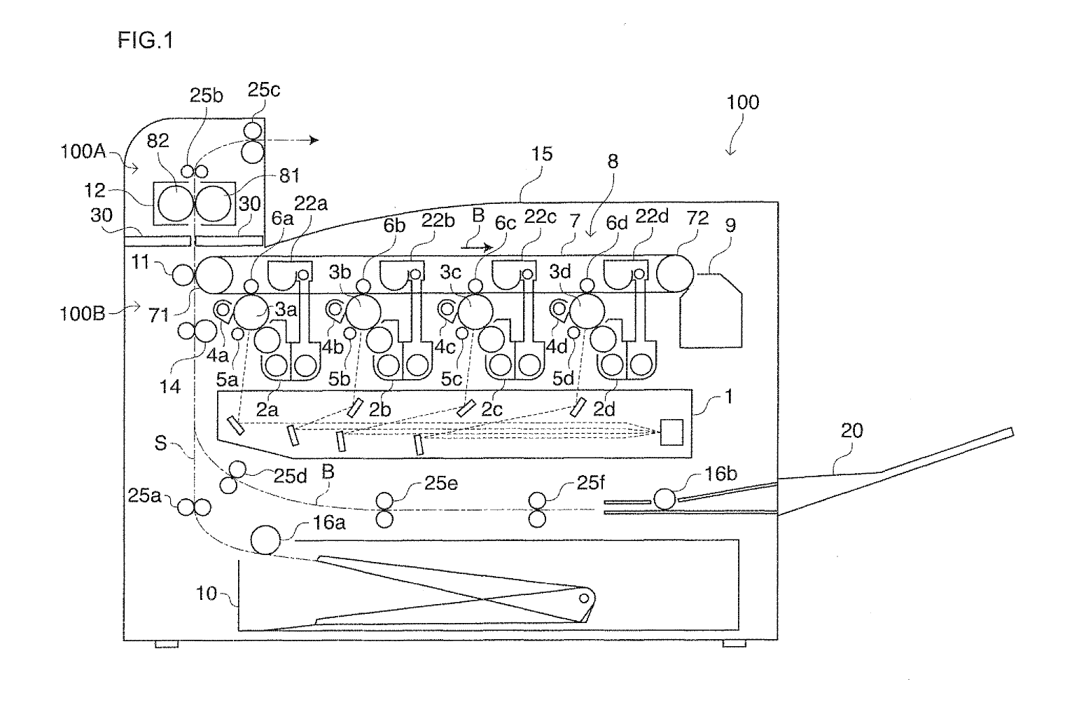

FIG. 1 is a diagram illustrating a structure of an image forming apparatus according to an embodiment of the present invention.

An image forming apparatus 100 is operable to form a multicolored image or a monochromatic image on a predetermined sheet (recoding paper, recoding medium) in accordance with image data acquired from the outside. A scanner or the like may be provided on the image forming apparatus 100.

The image forming apparatus 100 includes: a fuser unit housing 100A for housing a fuser unit 12; a developing device housing 100B for housing developing devices 2a, 2b, 2c, and 2d; and a partition 30 provided, between the fuser unit housing 100A and the developing device housing 100B, for insulating the developing device 2 from a heat for the fusing.

### [Fuser Unit Housing]

The fuser unit housing 100A accommodates: the fuser unit 12; and a conveying roller 25b and a paper discharge roller 25c for discharging, onto a paper output tray 15, a sheet having an image fused thereon, as shown in FIG. 1.

### (Fuser Unit)

The fuser unit 12 includes a heating roller 81 and a pressure-applying roller 82, and the heating roller 81 and the pressure-applying roller 82 sandwich the sheet therebetween and rotate. The heating roller 81 is controlled by a control section (not shown) so as to have a predetermined fusing temperature. The control section controls a temperature of the heating roller 81 based on a detection signal outputted from a temperature detector (not shown).

The heating roller 81 and the pressure-applying roller 82 thermally presses and fixes the sheet, to press a transferred toner image onto the sheet, while melting the transferred toner image, thereby fusing the toner image onto the sheet. The sheet having the toner image (a toner image of each color) fused thereon is discharged onto the paper output tray 15 by means of the conveying roller 25b and the paper discharge roller 25c.

### [Developing Device Housing]

As shown in FIG. 1, the developing device housing 100B accommodates: photoconductor drums 3a, 3b, 3c, and 3d having surfaces on which electrostatic latent images are formed; chargers (charging devices) 5a, 5b, 5c, and 5d for charging the surfaces of the photoconductor drums 3a, 3b, 3c, and 3d, respectively; an exposure unit (exposure device) 1 for forming electrostatic latent images on the surfaces of the photoconductor drums 3a, 3b, 3c, and 3d; developing devices 2a, 2b, 2c, and 2d for supplying toners to the electrostatic latent images on the surfaces of the photoconductor drums 3a, 3b, 3c, and 3d, respectively, to form toner images; toner supplies 22a, 22b, 22c, and 22d for supplying toners to the developing devices 2a, 2b, 2c, and 2d, respectively; and an intermediate transfer belt unit 8 for transferring, to a recording medium, the toner images on the surfaces of the photoconductor drums 3a, 3b, 3c, and 3d. Reference numeral a denotes black image forming members, reference numeral b denotes cyan image forming members, reference numeral c denotes magenta image forming members, and reference numeral d denotes yellow image forming members.

A black toner image, a cyan toner image, a magenta toner image, and a yellow toner image are formed on the surfaces of the photoconductor drums 3a, 3b, 3c, and 3d, based on image data of color components of black (K), cyan (C), magenta (M), and yellow (Y), respectively, which is inputted to the image forming apparatus 100. The toner images having been formed are superimposed on each other on the intermediate transfer belt unit 8, to form a color image.

Further, the image forming apparatus 100 also includes a sheet feed tray 10, and a sheet conveying path S.

Each of the photoconductor drums 3a, 3b, 3c, and 3d is a cylindrical component on which a latent image is formed through charging and exposure. The photoconductor drums 3a, 3b, 3c, and 3d each exhibit electric conductivity when a light is applied, and an electric image called an electrostatic latent image is formed on the surface of each of the photoconductor drums 3a, 3b, 3c, and 3d.

The photoconductor drums 3a, 3b, 3e, and 3d are supported and driven by driving means (not shown) so as to be rotatable about their shafts, respectively, and each include a conductive base body (not shown) and a photosensitive layer formed on the surface of the conductive base body.

Each of the chargers 5a, 5b, 5c, and 5d uniformly charges the surface of a corresponding one of the photoconductor drums 3a, 3b, 3c, and 3d at a predetermined potential. A contact brush type charger or a non-contact charging type charger as well as a contact roller-type charger as shown in FIG. 1 may be used.

The exposure unit 1 is an exposure device for applying, to the surfaces of the photoconductor drums 3a, 3b, 3c, and 3d, lights based on the image data, through between the chargers 5a, 5b, 5c, and 5d and the developing devices 2a, 2b, 2c, and 2d, respectively. In the present embodiment, a laser scanning unit (LSU) including a laser application section and a reflective mirror is used. However, an EL (electroluminescence) device having light emitting devices aligned in an array, and an LED write head as well as the laser scanning unit may be used as the exposure unit 1.

The exposure unit 1 light-exposes the photoconductor drums 3a, 3b, 3c, and 3d having been charged, in accordance with the image data having been inputted, to form the electrostatic latent images based on the image data, on the surfaces of the photoconductor drum 3.

The developing devices 2a, 2b, 2c, and 2d make visible (develop) the electrostatic latent images formed on the photoconductor drums 3a, 3b, 3c, and 3d by using the K toner, the C toner, the M toner, and the Y toner, respectively. The toner supplies 22a, 22b, 22c, and 22d are provided above the developing devices 2a, 2b, 2c, and 2d, respectively. Details thereof will be described below.

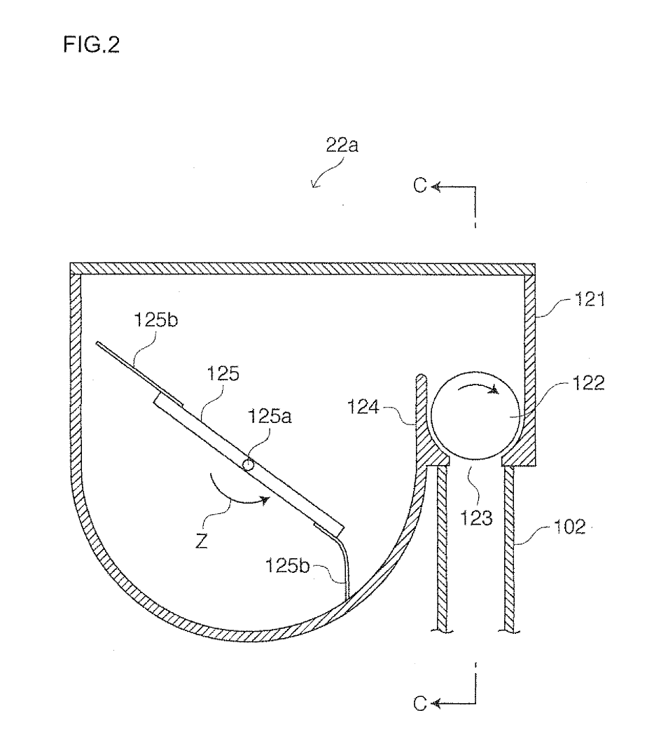

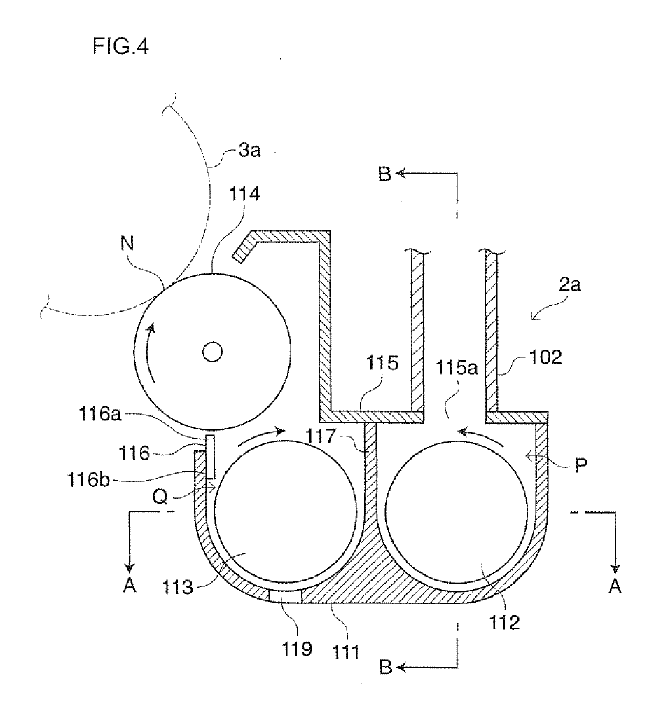

The toner supplies 22a, 22b, 22c, and 22d which contain unused toners (powdered toners) are provided above development tanks 111 (FIG. 4), respectively. The toners are supplied through toner conveying pipes 102 (FIGS. 2, 3, and 4) from the toner supplies 22a, 22b, 22c, and 22d to the development tanks 111, respectively. Details thereof will be described below.

Cleaner units 4a, 4b, 4c, and 4d shown in FIG. 1 are used to remove and collect toners which are left on the surfaces of the photoconductor drums 3a, 3b, 3c, and 3d, respectively, after development and image transfer.

The intermediate transfer belt unit 8 is disposed on the photoconductor drums 3a, 3b, 3c, and 3d. The intermediate transfer belt unit 8 includes: intermediate transfer rollers 6a, 6b, 6c, and 6d; an intermediate transfer belt 7, an intermediate transfer belt driving roller 71, an intermediate transfer belt follower roller 72, and an intermediate transfer belt cleaning unit 9.

The intermediate transfer belt 7 is extended on the intermediate transfer rollers 6a, 6b, 6c, and 6d, the intermediate transfer belt driving roller 71, and the intermediate transfer belt follower roller 72, and the intermediate transfer belt 7 is driven to rotate in the direction indicated by an arrow B shown in FIG. 1.

Transfer biases for transferring, on the intermediate transfer belt 7, the toner images on the photoconductor drums 3a, 3b, 3c, and 3d, are applied to the intermediate transfer rollers 6a, 6b, 6c, and 6d.

The intermediate transfer belt 7 is provided so as to contact with the photoconductor drums 3a, 3b, 3c, and 3d. The toner images of the color components formed on the photoconductor drums 3a, 3b, 3c, and 3d, respectively, are sequentially transferred onto the intermediate transfer belt 7 so as to be superimposed on each other, thereby forming a color toner image (multicolored toner image). The intermediate transfer belt 7 is formed as an endless belt by using a film having a thickness ranging from about 100 μm to about 150 μm, for example.

The toner images are transferred from the photoconductor drums 3a, 3b, 3c, and 3d onto the intermediate transfer belt 7 by means of the intermediate transfer rollers 6a, 6b, 6c, and 6d, respectively, which contact with the reverse side surface of the intermediate transfer belt 7. High-voltage transfer biases (high voltages having a polarity (+) opposite to a polarity (−) of a charged toner) are applied to the intermediate transfer rollers 6a, 6b, 6c, and 6d, respectively, for transferring the toner images.

Each of the intermediate transfer rollers 6a, 6b, 6c, and 6d is formed so as to include, as a base component, a metal (for example, stainless steel) shaft having a diameter ranging from 8 mm to 10 mm, for example, and the surface of each of the intermediate transfer rollers 6a, 6b, 6c, and 6d is covered with a conductive elastic material (for example, an EPDM or a urethane foam). The conductive elastic material enables the intermediate transfer roller 6 to uniformly apply a high voltage to the intermediate transfer belt 7. In the present embodiment, a roller type transfer electrode (the intermediate transfer roller 6) is used. However, a brush type electrode as well as the roller type electrode may be used.

As described above, the electrostatic latent images on the photoconductor drums 3a, 3b, 3c, and 3d are developed into toner images by using toners of the color components, respectively, and the toner images are superimposed on each other on the intermediate transfer belt 7. The superimposed toner image is moved to a position (transfer section) at which a conveyed sheet and the intermediate transfer belt 7 contact with each other, in accordance with the intermediate transfer belt 7 being rotated, and is transferred onto the sheet by means of a transfer roller 11 located at the position. In this case, the intermediate transfer belt 7 and the transfer roller 11 press and contact each other with a predetermined nip, and a voltage is applied to the transfer roller 11 for transferring the toner image to the sheet. The voltage to be applied is a high voltage having a polarity (+) opposite to a polarity (−) of the charged toner.

In order to constantly obtain the nip, one of the transfer roller 11 or the intermediate transfer belt driving roller 71 is formed of a hard material such as a metal, and the other thereof is formed of a flexible material as an elastic roller or the like (an elastic rubber roller, a foamable resin roller, or the like).

Toner which has not been transferred during the transfer of the toner image from the intermediate transfer belt 7 to the sheet, and have been left on the intermediate transfer belt 7, are removed and collected by the intermediate transfer belt cleaning unit 9 because the toner may cause mixture of the toner colors in subsequent process steps.

A cleaning blade (cleaning member) is provided in the intermediate transfer belt cleaning unit 9 so as to contact with the intermediate transfer belt 7. A portion of the intermediate transfer belt 7 which contacts with the cleaning blade is supported by the intermediate transfer belt follower roller 72 from the reverse side of the intermediate transfer belt 7.

The sheet feed tray 10 is used for storing sheets (for example, recording papers) on which images are formed, and is provided below the exposure unit 1. On the other hand, the paper output tray 15 provided in the upper portion of the image forming apparatus 100 is used for receiving sheets having images printed thereon face-down.

### (Toner Supply)

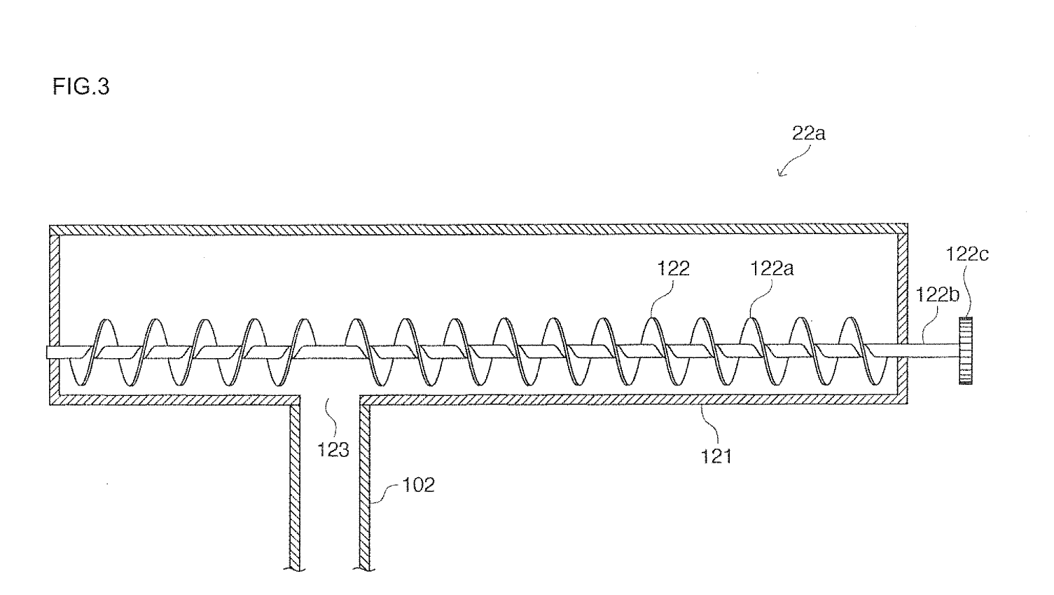

FIG. 2 is an enlarged view illustrating a structure of the toner supply shown in FIG. 1. FIG. 3 is a cross-sectional view taken in the direction of an arrow C-C shown in FIG. 2.

The toner supply 22a includes a toner container 121, a toner agitator 125, a toner discharge member 122, and a toner discharge outlet 123, as shown in FIG. 2. The toner supply 22a is disposed above the development tank 111 (FIG. 4), and contains unused toner (powdered toner). The toner in the toner supply 22a is supplied through the toner conveying pipe 102 from the toner discharge outlet 123 to the development tank 111 by the toner discharge member (discharge screw) 122 being rotated.

The toner container 121 is a container which has an almost semi-cylindrical shape, has an internal space, and contains toner. The toner container 121 supports the toner agitator 125 and the toner discharge member 122 so as to rotate the toner agitator 125 and the toner discharge member 122. The toner discharge outlet 123 is an opening which has an almost rectangular shape, and which is located below almost the center portion of the toner discharge member 122 in the axial direction in which the axis of the toner discharge member 122 extends. The toner discharge outlet 123 is disposed so as to communicate with the toner conveying pipe 102.

The toner agitator 125 is a plate-shaped member which scoops the toner contained in the toner container 121 and conveys the toner to the toner discharge member 122, while agitating the toner contained in the toner container 121, by rotating about a rotating shaft 125a. The toner agitator 125 has a toner scooping member 125b at the edges thereof. The toner scooping member 125b is formed as a flexible polyethylene terephthalate (PET) sheet.

The toner discharge member 122 supplies the toner contained in the toner container 121, through the toner discharge outlet 123, to the development tank 111. The toner discharge member 122 includes: an auger screw having a toner conveying blade 122a and a toner discharge member rotating shaft 122b; and a toner discharge member rotating gear 122c, as shown in FIG. 3. The toner discharge member 122 is driven to rotate by a toner discharge member drive motor (not shown). A direction in which the auger screw operates is set so as to convey the toner from the both ends of the toner discharge member 122 in the axial direction toward the toner discharge outlet 123.

A toner discharge member partition 124 is provided between the toner discharge member 122 and the toner agitator 125 as shown in FIG. 2. The toner discharge member partition 124 allows the toner scooped by the toner agitator 125 to be maintained in an appropriate amount around the toner discharge member 122.

The toner agitator 125 rotates in a direction indicated by an arrow Z as shown in FIG. 2 to agitate the toner and scoop the toner toward the toner discharge member 122. At this time, the toner scooping member 125b slides along the inner wall of the toner container 121, and rotates while being deformed, due to the toner scooping member 125b being flexible, thereby conveying the toner toward the toner discharge member 122. The toner having been conveyed is guided to the toner discharge outlet 123 by rotation of the toner discharge member 122.

The toner supplies 22b, 22c, and 22d each have the same structure and function as the toner supply 22a.

### (Developing Device)

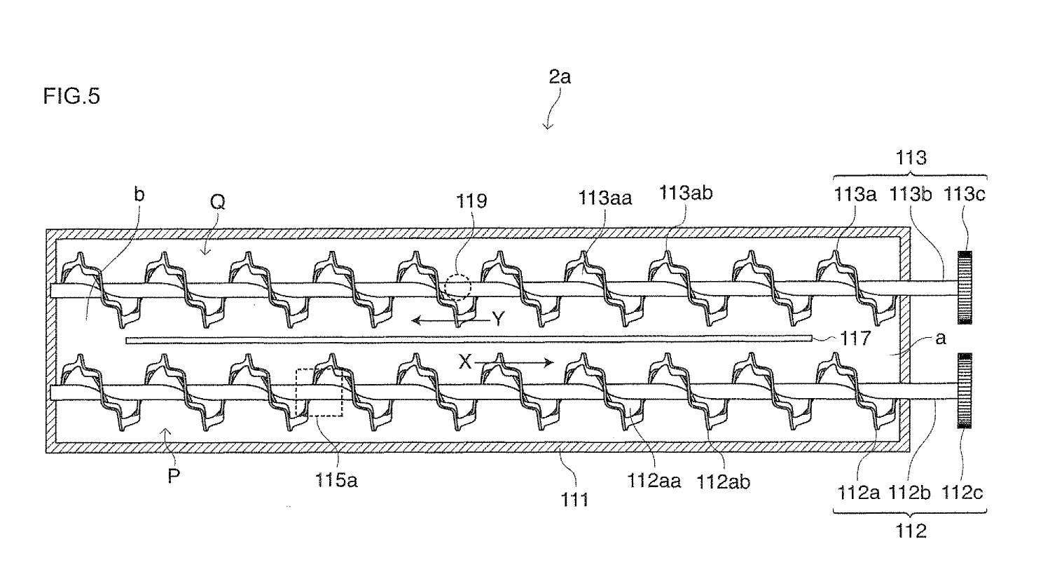

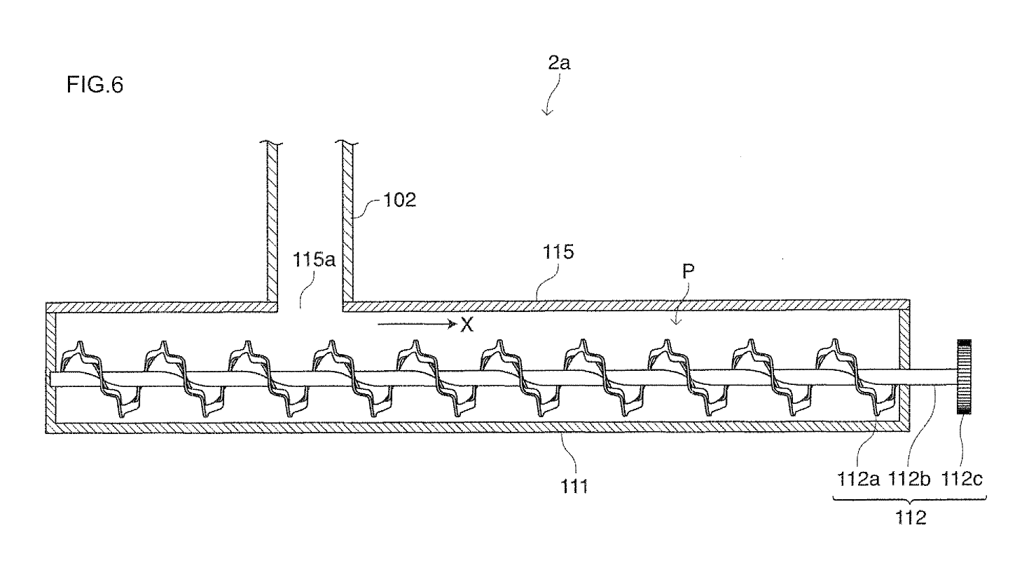

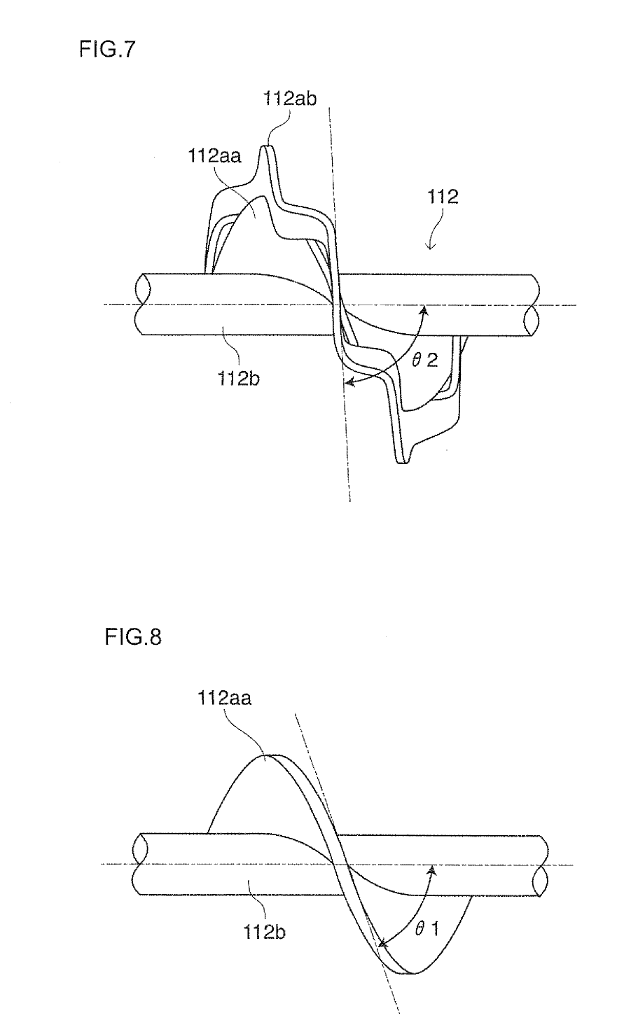

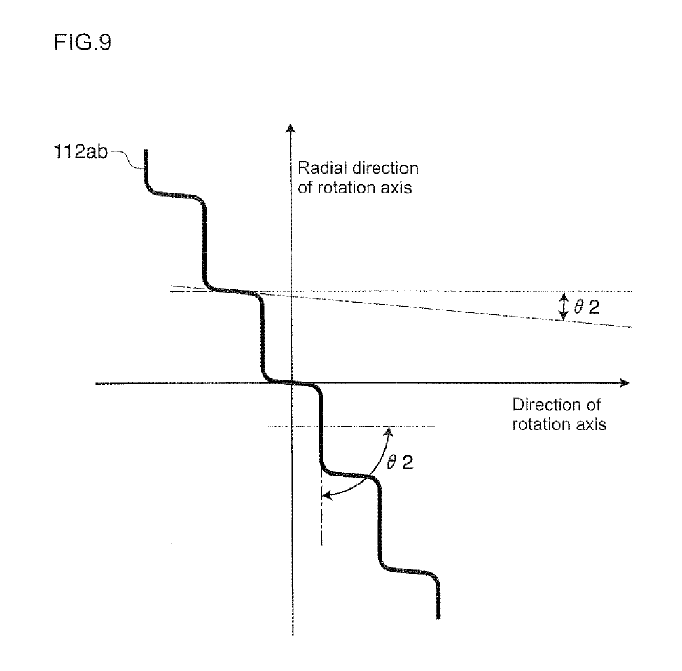

FIG. 4 is an enlarged view illustrating a structure of the developing device 2a shown in FIG. 1. FIG. 5 is a cross-sectional view taken in the direction of an arrow A-A shown in FIG. 4. FIG. 6 is a cross-sectional view taken in the direction of an arrow B-B shown in FIG. 4. FIG. 7 is an enlarged view of a main portion of a first agitation conveying member shown in FIG. 6. FIG. 8 is an enlarged view of a main portion of a first inner helical blade shown in FIG. 7. FIG. 9 is a development of a ring-shaped undulated helical blade, shown in FIG. 7, as viewed from the center of rotation of the first agitation conveying member in the rotation circumferential direction.

As shown in FIG. 4, the developing device 2a has, in the development tank 111, a developing roller 114 opposing the photoconductor drum 3a. The developing device 2a supplies toner to the surface of the photoconductor drum 3a by means of the developing roller 114 to make visible (develop) an electrostatic latent image formed on the surface of the photoconductor drum 3a.

The developing device 2a includes, in addition to the developing roller 114, the development tank 111, a development tank cover 115, a toner supply inlet 115a, a doctor blade 116, a first agitation conveying member 112, a second agitation conveying member 113, a partition (separation wall) 117, and a toner concentration detection sensor (magnetic permeability sensor) 119.

The development tank 111 stores a two-component developer (hereinafter, referred to simply as a “developer”) including a toner and a carrier. In the present embodiment, the carrier is a magnetic carrier.

The developing roller 114 is a magnet roller which is driven by driving means (not shown) to rotate about a rotating shaft. The developing roller 114 is operable to scoop onto and hold on the surface of the developing roller 114 the developer in the development tank 111, and to supply, to the photoconductor drum 3a, the toner included in the developer held on the surface.

Further, the developing roller 114 is provided so as to oppose the photoconductor drum 3, and so as to be spaced apart from the photoconductor drum 3 through a clearance. The developer conveyed by the developing roller 114 contacts with the photoconductor drum 3a at a portion at which the distance between the developing roller 114 and the photoconductor drum 3a is minimal. The portion at which the developer contacts with the photoconductor drum 3a acts as a development nip portion N. In the development nip portion N, a development bias voltage is applied to the developing roller 114 from a power supply (not shown) connected to the developing roller 114, and the toner in the developer on the surface of the developing roller 114 is supplied to the electrostatic latent image on the surface of the photoconductor drum 3a.

The doctor blade 116 is disposed so as to be adjacent to the surface of the developing roller 114. The doctor blade 116 is a rectangular plate-shaped member which extends parallel to the direction in which the axis of the developing roller 114 extends. A lower end 116b of the doctor blade 116 is supported by the development tank cover 115, and an upper end edge 116a of the doctor blade 116 is spaced apart from the surface of the developing roller 114 through a clearance. As a material of the doctor blade 116, aluminium or a synthetic resin as well as stainless steel may be used.

### First Agitation Conveying Member

The first agitation conveying member (developer conveying member) 112 includes: a helical auger screw having a first conveying blade 112a and a first rotating shaft 112b; and a first conveying gear 112c, as shown in FIG. 5 to FIG. 9. The first conveying blade 112a includes: a first inner helical blade 112aa which is helically provided along the outer circumference of the first rotating shaft 112b; and a first ring-shaped undulated helical blade 112ab provided so as to contact with the outer circumference of the first inner helical blade 112aa. The first agitation conveying member 112 is driven to rotate by driving means such as a motor (not shown), such that the developer being conveyed is agitated.

The first ring-shaped undulated helical blade 112ab is a helical blade which is ring-shaped as viewed along the rotation axis, and which has an undulated surface including a developer pressing surface having an angle of attack which changes in a cyclic manner, in accordance with the rotation of the shaft, as shown in FIG. 7. The first ring-shaped undulated helical blade 112ab forms a smoothly curved surface such that the angle of attack sequentially changes at rotation intervals of 72 degrees relative to the rotation axis, that is, such that the number of cycles of the change is 5 (360 degress/72 degrees).

Further, a minimum value of an angle θ2 of attack (minimum angle of attack) and a maximum value of the angle θ2 of attack (maximum angle of attack) of the first ring-shaped undulated helical blade 112ab shown in FIG. 9 are set to 10 degrees and 80 degrees, respectively. The angle θ1 of attack of the first inner helical blade 112aa shown in FIG. 8 is set to 50 degrees.

In the present invention, the angle of attack represents an angle θ1 (FIG. 8) between the axis of the first rotating shaft 112b and the tangent line (developer pressing surface) to the first inner helical blade 112aa, and an angle θ2 (FIG. 7) between the axis of the first rotating shaft 112b and the tangent line (developer pressing surface) to the first ring-shaped undulated helical blade 112ab. Further, the rotation interval represents an angle of rotation of the first helical blade 112a about the axis of the first rotating shaft 112b on a surface orthogonal to the first rotating shaft 112b.

### Second Agitation Conveying Member

The second agitation conveying member (developer conveying member) 113 has a structure similar to that of the first agitation conveying member 112. Specifically, the second agitation conveying member 113 includes: a helical auger screw having a second conveying blade 113a and a second rotating shaft 113b; and a second conveying gear 113c, as shown in FIG. 5 to FIG. 9. The second conveying blade 113a includes: a second inner helical blade 113aa which is helically provided along the outer circumference of the second rotating shaft 113b; and a second ring-shaped undulated helical blade 113ab provided so as to contact with the outer circumference of the second inner helical blade 113aa. The second agitation conveying member 113 is driven to rotate by driving means such as a motor (not shown), such that the developer being conveyed is agitated.

The second ring-shaped undulated helical blade 113ab has the same structure as the first ring-shaped undulated helical blade 112ab. Specifically, the second ring-shaped undulated helical blade 113ab is a helical blade which is ring-shaped as viewed along the rotation axis, and which has an undulated surface including a developer pressing surface having an angle of attack which changes in a cyclic manner. The second ring-shaped undulated helical blade 113ab forms a smoothly curved surface such that the angle of attack sequentially changes at rotation intervals of 72 degrees relative to the rotation axis, that is, such that the number of cycles of the change is 5 (360 degrees/72 degrees).

A minimum value of an angle of attack (minimum angle of attack) and a maximum value of the angle of attack (maximum angle of attack) of the second ring-shaped undulated helical blade 113ab are set to 10 degrees and 80 degrees, respectively. The angle of attack of the second inner helical blade 113aa is set to 50 degrees, similarly to the angle θ1 of attack (FIG. 8) of the first inner helical blade 112aa.

The toner concentration detection sensor 119 shown in FIG. 4 is mounted on the bottom surface of the development tank 111 vertically below almost the center portion of the second agitation conveying member 113 in the developer conveying direction, as shown in the FIG. 5. The sensor is mounted so as to expose the surface of the sensor into the inside of the development tank 111. The toner concentration detection sensor 119 is electrically connected to toner concentration control means (not shown). The toner concentration control means drives the toner discharge member 122 to rotate for supplying the toner through the toner discharge outlet 123 into the development tank 111, as shown in FIG. 3, in accordance with a toner concentration measurement value detected by the toner concentration detection sensor 119.

When the toner concentration measurement value obtained by the toner concentration detection sensor 119 is determined as being less than a predetermined toner concentration value, a control signal is transmitted to driving means for driving the toner discharge member 122 to rotate. Thus, the toner discharge member 122 is driven to rotate. A generally used toner concentration detection sensor can be used as the toner concentration detection sensor 119. Examples of the toner concentration detection sensor include a transmitted-light detection sensor, a reflected-light detection sensor, and a magnetic-permeability detection sensor. Among them, a magnetic-permeability detection sensor is preferably used.

A magnetic-permeability detection sensor is connected to a power supply (not shown). A drive voltage for driving the magnetic-permeability detection sensor and a control voltage for outputting, to the control means, a toner concentration detection result are applied to the magnetic-permeability detection sensor from the power supply. The application of the voltage to the magnetic-permeability detection sensor from the power supply is controlled by the control means. The magnetic-permeability detection sensor is such a sensor as to output the toner concentration detection result as an output voltage value in accordance with the control voltage being applied. The control voltage to be applied is a control voltage for enabling the magnetic-permeability detection sensor to output the output voltage with high sensitivity. The magnetic-permeability detection sensor of such a type is commercially available, and examples of such a magnetic-permeability detection sensor include TS-L, TS-A, and TS-K (all of which are product names, and are manufactured by TDK Corporation).

Further, the removable development tank cover 115 is provided on the upper side of the development tank 111, as shown in FIG. 4. Moreover, the development tank cover 115 has formed thereon the toner supply inlet 115a through which unused toner is supplied into the development tank 111.

As shown in FIG. 1, the toner contained in the toner supply 22a is conveyed in the toner conveying pipe 102 through the toner supply inlet 115a into the development tank 111, thereby supplying the toner to the development tank 111.

In the development tank 111, the partition 117 is provided between the first agitation conveying member 112 and the second agitation conveying member 113 as shown in FIG. 4. The partition 117 extends parallel to the direction in which the shafts (rotation axes) of the first agitation conveying member 112 and the second agitation conveying member 113 extend, as shown in FIG. 5. An inside of the development tank 111 is separated by the partition 117 into a first conveying path P in which the first agitation conveying member 112 is disposed, and a second conveying path Q in which the second agitation conveying member 113 is disposed.

The partition 117 is spaced apart from an inner wall surface of the development tank 111 near both ends of each of the first agitation conveying member 112 and the second agitation conveying member 113 in the direction in which the shafts thereof extend. Thus, in the development tank 111, communication paths for communicating between the first conveying path P and the second conveying path Q are formed near both ends of each of the first agitation conveying member 112 and the second agitation conveying member 113 in the direction in which the shafts thereof extend. Hereinafter, a communication path formed near the end of each of the members 112 and 113 in the direction indicated by an arrow X is referred to as a first communication path a, whereas a communication path formed near the end of each of the members 112 and 113 in the direction indicated by an arrow Y is referred to as a second communication path b, as shown in FIG. 5.

The first agitation conveying member 112 and the second agitation conveying member 113 are aligned such that the circumferential surfaces thereof are opposed to each other through the partition 117 and the shafts thereof extend parallel to each other, and the first agitation conveying member 112 and the second agitation conveying member 113 are designed to rotate in directions, respectively, opposite to each other. The first agitation conveying member 112 conveys the developer in the direction indicated by the arrow X, whereas the second agitation conveying member 113 conveys the developer in the direction indicated by the arrow Y which is opposite to the direction indicated the arrow X, as shown in FIG. 5.

The toner supply inlet 115a is formed, in the first conveying path P, forward of the second communication path b in the direction indicated by the arrow X, as shown in FIG. 5. Namely, toner is supplied through a portion downstream of the second communication path b in the first conveying path P.

In the development tank 111, the first agitation conveying member 112 and the second agitation conveying member 113 are driven to rotate by driving means such as a motor (not shown), to convey the developer.

Specifically, the developer being agitated is conveyed in the first conveying path P in the direction indicated by the arrow X by means of the first agitation conveying member 112, to reach the first communication path a. The developer having reached the first communication path a is conveyed through the first communication path a into the second conveying path Q.

On the other hand, the developer being agitated is conveyed in the second conveying path Q in the direction indicated by the arrow Y by means of the second agitation conveying member 113, to reach the second communication path b. The developer having reached the second communication path b is conveyed through the second communication path b into the first conveying path P.

Namely, the first agitation conveying member 112 and the second agitation conveying member 113 convey the developer in the directions, respectively, opposite to each other while agitating the developer.

Thus, the developer is circulated and conveyed in the first conveying path P, the first communication path a, the second conveying path Q, and the second communication path b in the development tank 111 in order of the first conveying path P→the first communication path a→the second conveying path Q→the second communication path b. While the developer is being conveyed in the second conveying path Q, the developer is held on and scooped onto the surface of the developing roller 114 (FIG. 4) by the developing roller 114 being rotated, and the toner contained in the developer having been scooped is supplied to the photoconductor drum 3, thereby sequentially consuming the toner.

In order to compensate for the toner having been thus consumed, unused toner is supplied through the toner supply inlet 115a into the first conveying path P. The toner having been supplied is mixed and agitated with the developer having been previously contained in the first conveying path P.

The developing devices 2b, 2c, and 2d each have the same structure and function as the developing device 2a.

### (Sheet Conveying Path)

As shown in FIG. 1, the image forming apparatus 100 includes the sheet conveying path S for guiding sheets fed from the sheet feed tray 10 and sheets fed from a manual bypass tray 20, to the paper output tray 15, through the transfer section, the fuser unit 12, and the like. The transfer section is formed between the intermediate transfer belt driving roller 71 and the transfer roller 11.

Further, pick-up rollers 16a and 16b, a resist roller 14, the fuser unit 12, conveying rollers 25a, 25b, 25d, 25e, and 25f, the paper discharge roller 25c, and the like are disposed in the sheet conveying path S.

The conveying rollers 25a, 25b, 25d, 25e, and 25f, and the paper discharge roller 25c are a plurality of small rollers provided along the sheet conveying path S for promoting and assisting in conveying of the sheets. The pick-up roller 16a is a feed roller provided at the end portion of the sheet feed tray 10 for feeding one by one the sheets from the sheet feed tray 10 to the sheet conveying path S. The pick-up roller 16b is a feed roller provided near the manual bypass tray 20 for feeding one by one the sheets from the manual bypass tray 20 to the sheet conveying path S. The resist roller 14 temporarily holds the sheet being conveyed in the sheet conveying path S, and feeds the sheet to the transfer section in accordance with a time at which a position of the toner image on the intermediate transfer belt 7 and a position of the sheet are aligned with each other.

Next, the sheet conveying operation of the sheet conveying path S will be described.

A sheet fed from the sheet feed tray 10 is conveyed to the resist roller 14 by means of the conveying roller 25a in the sheet conveying path S, and is conveyed to the transfer section (a position at which the transfer roller 11 and the intermediate transfer belt 7 contact with each other) by means of the resist roller 14 in accordance with a time at which the position of the sheet and the position of the superimposed toner image on the intermediate transfer belt 7 are aligned with each other. At the transfer section, the toner image is transferred onto the sheet, and the toner image is fused onto the sheet by means of the fuser unit 12. Thereafter, the sheet is discharged onto the paper output tray 15 through the paper discharge roller 25c from the conveying roller 25b.

On the other hand, a sheet fed from the manual bypass tray 20 is conveyed to the resist roller 14 by means of a plurality of conveying rollers 25f, 25e, and 25d. In the subsequent sheet conveying process steps, the sheet from the manual bypass tray 20 is discharged onto the paper output tray 15 through the same process steps as those for the sheet fed from the sheet feed tray 10 described above.

What is claimed is:

1. A developing device comprising:
a developer container for containing a developer including a toner and a magnetic carrier;
a developer conveying path provided in the developer container;
a developer conveying member, provided in the developer conveying path, for agitating and conveying the developer; and
a developing roller for holding the agitated developer so that the toner included in the developer is supplied to a photoconductor drum, wherein the developer conveying member includes a rotating shaft, and an undulated helical blade provided along an outer circumference of the rotating shaft.

2. The developing device of claim 1, wherein the undulated helical blade includes: an inner helical blade provided along the outer circumference of the rotating shaft; and a ring-shaped undulated helical blade provided so as to contact with an outer circumference of the inner helical blade.

3. The developing device of claim 2, wherein the ring-shaped undulated helical blade has waves of not less than two and not more than 12 every rotation.

4. The developing device of claim 3, wherein the ring-shaped undulated helical blade has an attack angle which sequentially changes in accordance with rotation of the rotating shaft.

5. The developing device of claim 4, wherein the ring-shaped undulated helical blade has a minimum attack angle of not less than 0 degree and not less than 25 degrees.

6. The developing device of claim 5, wherein the inner helical blade has a maximum attack angle of not less than 45 degrees and not more than 60 degrees.

7. An image forming apparatus comprising:
a photoconductor drum;
a charging unit for charging the photoconductor drum;
an exposure unit for forming an electrostatic latent image on the photoconductor drum;
a developing device for supplying a toner to the electrostatic latent image on the photoconductor drum to form a toner image;
a transfer unit for transferring the toner image to a recording medium;
and a fuser unit for fusing the transferred toner image onto the recording medium, wherein the developing device is a developing device according to claim 1.
